(19) United States
(12) Patent Application Publication
(10) Pub. No.: US 2018/0043657 A1
(43) Pub. Date: Feb. 15, 2018

(54) COMPONENT MADE OF THERMOPLASTIC COMPOSITE MATERIAL WITH INCREASED NOTCHED BAR IMPACT STRENGTH

(71) Applicant: INEOS STYROLUTION GROUP GMBH, Frankfurt am Main (DE)

(72) Inventors: Achim BERNHARDT, Hainburg (DE); Eike JAHNKE, Aubonne (CH); Marko BLINZLER, Mannheim (DE); Stefan ROETTEL, Gummersbach (DE); Norbert NIESSNER, Friedelsheim (DE)

(21) Appl. No.: 15/551,457

(22) PCT Filed: Feb. 18, 2016
(86) PCT No.: PCT/EP2016/053414

§ 371 Date: Aug. 16, 2017

(30) Foreign Application Priority Data
Feb. 19, 2015 (EP) 15155697.4

(51) Int. Cl. B32B 7/02; B32B 27/20; B32B 27/30; B32B 27/08

(52) U.S. Cl. CPC B32B 7/02; B32B 27/08; B32B 27/20; B32B 27/302; B32B 2264/101; B32B 2307/558; B29C 45/14811

(57) ABSTRACT

The invention relates to a component made of thermoplastic composite material, comprising a core K and at least one coating G, wherein: the coating G at least partially surrounds the core K, the core K is made of a first thermoplastic moulding compound M1, the first thermoplastic moulding compound M1 contains multiple shaped bodies F, and the coating G is made of a second thermoplastic moulding compound M2. The invention also relates to a method for producing the component.

The present invention relates to a component made of thermoplastic composite material, comprising a core K and at least one coating G, where the coating G at least to some extent encloses the core K. The invention further relates to a process for the production of the component.

It is known that thermoplastic molding compositions can be produced with various fillers. By way of example, U.S. Pat. No. 3,951,906 discloses a composition with glass fibers. Molding compositions reinforced with glass fibers usually have increased stiffness and strength, but significantly reduced elasticity and notched impact resistance.

WO 2008/110539 describes fiber-composite materials comprising from 15 to 95% by weight, based on the weight of the fiber-composite material, of a thermoplastic matrix comprising from 0 to 99% by weight, based on the weight of the thermoplastic matrix, of a styrene-acrylonitrile copolymer and/or of an α-methylstyrene-acrylonitrile copolymer as component A, and from 1 to 100% by weight, based on the weight of the thermoplastic matrix, of a styrene-acrylonitrile-maleic anhydride copolymer and/or of an α-methylstyrene-acrylonitrile-maleic anhydride copolymer as component B, and from 0 to 50% by weight of an elastomeric polymer as component C, and from 0 to 50% by weight, based on the weight of the thermoplastic matrix, of conventional plastics additives as component D, where the entirety of components A, B, C and D provides 100% by weight, and from 5 to 85% by weight, based on the weight of the fiber-composite material, of glass fibers G, where the entirety of the thermoplastic matrix and of the glass fibers G provides 100% by weight, and processes for the production of fiber-composite materials.

DE-A 34 36 602 describes thermoplastic molding compositions reinforced with glass fibers and consisting of a styrene polymer A comprising acrylonitrile and methacrylates, a styrene polymer B comprising acrylonitrile-maleimides, and a styrene-containing polymer C comprising acrylonitrile, and a rubber component D. The physical properties of the polymer mixture reveal that adhesion between the glass fibers and the copolymers is inadequate.

U.S. Pat. No. 6,211,269 describes the use of tin-containing organic compounds to improve adhesion between glass fibers and an acrylonitrile-butadiene-styrene (ABS) composition.

U.S. Pat. No. 5,039,719 discloses the use of maleic-anhydride-containing copolymers or thermoplastic polyurethanes comprising isocyanate groups to improve adhesion between glass fibers and an ABS copolymer.

The application JP H 04104922 discloses a binder for copolymer comprising glass fibers.

WO 2008/119678 describes an acrylonitrile-butadiene-styrene composition reinforced with glass fibers and having improved stiffness and toughness. The following thermoplastic molding composition is mentioned: from 5 to 95% of a copolymer A consisting of: from 70 to 76% of a vinylaromatic monomer A1, from 24 to 30% of a vinyl cyanide monomer component A2 and from 0 to 50% of one or more unsaturated copolymerizable monomers A3, from 0 to 60% of a rubber component B and from 5 to 50% of thin glass fibers C, where the thermoplastic molding composition is injection-moldable.

U.S. Pat. No. 4,745,139 relates to a composition for the surface-coating by way of example of elastomers and plastics foams. The composition comprises styrene-ethylene-butylene-styrene and methyl methacrylate copolymers and pulverulent silicon dioxides and glass microspheres as filler material. The surface-coating composition can achieve uniform roughness and slip resistance of the coated surface.

JP H 0423851 and JP H 0423849 disclose styrene-based resin compositions which comprise carbon fibers and hollow glass spheres as fillers. The compositions comprise from 60% by weight to 90% by weight of styrene-based resin, for example ABS, and from 10% by weight to 40% by weight of inorganic filler material composed of from 20% by weight to 80% by weight of carbon fibers and from 20% by weight to 80% by weight of glass spheres.

JP H 0423848 describes ABS molding compositions with hollow glass spheres.

Moldings known from the prior art comprising thermoplastic molding compositions, in particular molding compositions having relatively low density because they comprise glass and/or hollow spheres, have low notched impact resistance, and the possibilities for use of these molding compositions are therefore limited.

It is an object of the present to provide a component which has increased notched impact resistance, made of a molding composition comprising moldings as fillers.

The object is achieved via a component made of thermoplastic composite material, comprising a core K and at least one coating G, where:

the coating G at least to some extent encloses the core K,
the core K has been produced from a first thermoplastic molding composition M1,
where the first thermoplastic molding composition M1 comprises a plurality of moldings F, and the coating G has been produced from a second thermoplastic molding composition M2.

The thermoplastic molding composition M1 is often based on (at least) a styrene polymer or styrene copolymer and the moldings F.

By virtue of the coating G on the core K, which comprises the moldings F, a composite material is formed, where the coating G provides increased notched impact resistance to the component and splintering on fracture of the component is thus reduced. The coating G provides access to the increased notched impact resistance as additional property, while other properties of the first thermoplastic molding composition M1 itself, for example low density, are also very substantially retained for the component made of the composite material comprising the core K and the coating G. The coating G can also be regarded as protective layer for the component. In particular in the automobile production sector it is thus possible to comply with more stringent requirements relating to the fracture behavior of materials, for example for a use in the interior of a vehicle. The increased notched impact resistance of the components of the invention, and their reduced tendency toward splintering, permits their use by way of example in the head-impact region in the interior of motor vehicles.

The presence of the coating G on the core K moreover permits achievement of a smoother component surface.

For the purposes of the present invention, the term “core” is understood to mean that the proportion of the core K and of the first thermoplastic molding composition M1 in the component is substantial, i.e. more than 40% by weight, more preferably more than 50% by weight, often 85% by weight or more, based on the total composition of the component. The coating G is arranged on the core K, the thickness of the core K here preferably being greater than the thickness of the coating G.

It is preferable that the thickness of the core K is greater than the thickness of the coating G by a factor of at least 1.2 and at most 20, where in each case the value to be adduced is the greatest thickness, based on the entire component. In particular, the core K consists of the first thermoplastic molding composition M1 and the coating G consists of the second thermoplastic molding composition M2.

The component preferably comprises from 5% by weight to 30% by weight, based on the composition of the entire component, of the second thermoplastic molding composition M2, more preferably from 20% by weight to 30% by weight and with particular preference from 23 to 27% by weight.

The resultant thickness of the coating G, greater than that of by way of example lacquer layers, is advantageous for absorbing mechanical forces and therefore for increasing the notched impact resistance of the component. The coating G has a stabilizing effect.

The moldings F are preferably hollow bodies. The interior of a hollow body comprises a cavity, sealed with respect to the environment of the hollow body. The cavity of the hollow body can comprise a gas, for example air or nitrogen, and the prevailing pressure in the cavity of the hollow body can be lower than in the environment of the hollow body.

The hollow bodies have a ratio of the average greatest external diameter of the hollow bodies to the average smallest wall thickness of the hollow bodies of from 2.05 to 10, more preferably from 2.1 to 5, with further preference from 2.2 to 4, particularly preferably from 2.3 to 3 and with particular preference from 2.4 to 2.8, for example 2.6.

The wall thickness describes the thickness of material between the cavity and the environment of the moldings F. The first thermoplastic molding composition M1 comprises a plurality of moldings F, i.e. more than one molding F, and the average greatest external diameter and the average smallest wall thickness denote in each case the arithmetic average, based on the moldings F comprised in the first thermoplastic molding composition M1. The smallest wall thickness and the greatest external diameter are based in each case on the individual molding F. The preferred ratio of external diameter to wall thickness ensures that the density of the first thermoplastic molding composition M1 is reduced and at the same time the individual moldings have the required stability.

In particular when the moldings F take the form of hollow bodies, presence of the moldings F can reduce the density of the first thermoplastic molding composition M1, and the component can be used for lightweight construction applications. In this way it is possible by way of example to reduce the total weight of equipment installed in a vehicle and thus reduce fuel consumption.

Based on the composition of the moldings F, preferably at least 60% by weight of said moldings consists of glass, more preferably at least 80% by weight, particularly preferably at least 90% by weight and with particular preference at least 95% by weight. For the purposes of the invention, glass is considered to be polymerized silicate, and therefore the term polymerization is also relevant to the production and shaping of glass.

The use of glass for the moldings F has the advantage that the moldings F are dimensionally stable during the processing of the first thermoplastic molding composition M1, with the result that any cavity present is retained in the molding F and the overall effect is to achieve low density of the first thermoplastic molding composition M1.

In an alternative embodiment, the proportion of a (thermo)plastic in the moldings F, based on the composition of the moldings F, is at least 60% by weight, more preferably at least 80% by weight, particularly preferably at least 90% by weight and with particular preference at least 95% by weight. The plastic is preferably selected from the group consisting of uncrosslinked polymers, for example polystyrene (PS), and crosslinked polymers, for example polymethyl methacrylate/polystyrene copolymers and polycarbonate. Particular preference is given to crosslinked polymers which are in particular PS/PMMA-based.

The moldings F are preferably spherical. For the purposes of the invention, the meaning of the term spherical also includes shapes deviating slightly from the spherical shape, for example ellipsoids. The longest spatial dimension of the moldings F is preferably in the range from 1 μm to 1000 μm, more preferably from 2 μm to 200 μm, particularly preferably from 2 μm to 100 μm and with particular preference from 5 μm to 50 μm. The longest spatial dimension of the moldings F is based on the arithmetic-average longest spatial dimension throughout the entirety of the moldings F in the first thermoplastic molding composition M1.

In a preferred embodiment, based on the entire composition of the first thermoplastic molding composition M1, said molding composition consists of from 1% by weight to 50% by weight, particularly preferably from 2% by weight to 30% by weight, of the moldings F.

The density of the first thermoplastic molding composition M1 is preferably from 0.1 g/cm³ to 1 g/cm³, more preferably from 0.5 g/cm³ to 1 g/cm³, particularly preferably from 0.6 g/cm³ to 0.9 g/cm³ and with particular preference from 0.7 g/cm³ to 0.8 g/cm³.

The relatively low density of the first thermoplastic molding composition M1 permits use of the component in lightweight construction applications. These are in particular mobile applications, for example in vehicle construction.

It is preferable that the notched impact resistance determinable in accordance with DIN EN ISO 179-1 of the second thermoplastic molding composition M2 is higher than that of the first thermoplastic molding composition M1. Said notched impact resistance can by way of example be at least 10% higher. The presence of the second thermoplastic molding composition M2 on the first thermoplastic molding composition M1 leads to increased notched impact resistance of the entire component.

The coating G can in particular be a film, a sheet or a second component. It is particularly preferable that the second thermoplastic molding composition M2 takes the form of a film. The meaning of the expression second component in this context is by way of example that the second thermoplastic molding composition M2 takes the form of dimensionally stable film and has already been cut to size and has a three-dimensionally defined shape before the second thermoplastic molding composition M2 is joined as coating G to the core K made of the first thermoplastic molding composition M1 to give the composite material.

In a preferred embodiment, the component comprises, in addition to the core K and the coating G, a further layer S which is composed of a third thermoplastic molding composition M3 which has higher notched impact resistance than the first thermoplastic molding composition M1, where the core K is arranged between the coating G and the further layer S. It is preferable that the coating G, or the coating G and the further layer S, entirely enclose(s) the core K.

If the further layer S is present, the component comprises a layer structure comprising the coating G, the core K and the further layer S. It is preferable that the component consists of the core K and the coating G, or of the core K, the coating G and the further layer S.

Irrespective of whether the component comprises no further layer S or comprises the further layer S, said component preferably comprises from 5% by weight to 30% by weight, based on the composition of the entire component, of the second thermoplastic molding composition M2, more preferably from 20% by weight to 30% by weight and with particular preference from 23 to 27% by weight. If the component comprises the further layer S, the composition of the further layer S is taken into account in the composition of the entire component.

If the further layer S is present, the component therefore preferably comprises from 5% by weight to 30% by weight of the third thermoplastic molding composition M3, more preferably from 20% by weight to 30% by weight and with particular preference from 23 to 27% by weight.

In general, the moldings F are comprised only in the first thermoplastic molding composition M1, while the second thermoplastic molding composition M2 and the third thermoplastic molding composition M3 comprise no moldings F.

The composition of the third molding composition M3 and of the second thermoplastic molding composition M2 can be identical. Alternatively, the compositions of the third thermoplastic molding composition M3 and of the second thermoplastic molding composition M2 can differ from one another. The latter situation is advantageous when it is desirable that different sides of the component have a different type of surface.

The first thermoplastic molding composition M1 preferably consists of a polymer matrix (e.g. made of styrene copolymer) and of the moldings F. It is possible in a component of the invention that the composition of the polymer matrix of the first thermoplastic molding composition M1, the composition of the second thermoplastic molding composition M2 and the composition of the third thermoplastic molding composition M3 are identical or differ from one another. It is preferable that the second thermoplastic molding composition M2 and the third thermoplastic molding composition M3 comprise in each case polymers or copolymers selected from the group consisting of polystyrene (PS), styrene-butadiene rubber (SB), styrene-acrylonitrile (SAN), styrene-methyl methacrylate (SMMA), acrylonitrile-butadiene-styrene (ABS), acrylonitrile-butadiene-styrene/polyamide (ABS/PA), acrylonitrile-butadiene-styrene/polycarbonate (ABS/PC), acrylonitrile-butadiene-styrene/polymethyl methacrylate (ABS/PMMA), acrylonitrile-butadiene-styrene/styrene-methyl methacrylate (ABS/SMMA), acrylate-styrene-acrylonitrile (ASA), acrylate-styrene-acrylonitrile/polyamide (ASA/PA), acrylate-styrene-acrylonitrile/polycarbonate (ASA/PC), acrylate-styrene-acrylonitrile/polymethyl methacrylate (ASA/PMMA), acrylate-styrene-acrylonitrile/styrene-methyl methacrylate (ASA/SMMA) and mixtures thereof.

In general the compositions described hereinafter for the polymer matrix of the first thermoplastic molding composition M1 are also suitable as compositions of the second thermoplastic molding composition M2 and of the third thermoplastic molding composition M3. It is further preferable that the composition of the polymer matrix of the first thermoplastic molding composition M1 and of the second thermoplastic molding composition M2 is identical (e.g. SAN, ABS or ASA). An advantage of this embodiment is that good adhesion is achieved between the core K and the coating G and it is possible to omit use of additional compatibilizers between core K and coating G. The expression polymer matrix of the first thermoplastic molding composition M1 denotes that portion of the first thermoplastic molding composition M1 that does not consist of the moldings F.

Alternatively, the composition of the polymer matrix of the first thermoplastic molding composition M1 and of the second thermoplastic molding composition M2 can differ from one another.

It is preferable that the coating G is arranged in direct contact with the core K and, if present, the further layer S is arranged in direct contact with the core K. Accordingly, in this situation there is bonding over a substantial area between the coating G and the core K and between, if present, the further layer S and the core K. In general, contact between the coating G and the further layer S exists only over an area that is no wider than the thickness of the coating G and the thickness of the further layer S. In an alternative embodiment, the coating G and the further layer S are arranged on the core K without any points of mutual contact.

The coating G and/or the further layer S preferably form(s) an exterior surface of the component. In this embodiment, one side of the coating G faces in the direction of the core K and a second, opposite side of the coating G faces toward the environment of the component. The same applies correspondingly to the further layer S, if present.

In an alternative embodiment, there is a supplementary layer arranged on the coating G and/or on the further layer S, on that side of the coating G and/or of the further layer S that faces away from the core; it is thus possible by way of example to apply an additional lacquer layer. The average thickness of the supplementary layer is preferably smaller than the average thickness of the coating G and the average thickness of the further layer S.

It is preferable that the first thermoplastic molding composition M1 comprises from 50% by weight to 95% by weight, in particular from 50% by weight to 70% by weight, of a polystyrene or of a styrene copolymer. With particular preference the first thermoplastic molding composition M1 comprises from 50% by weight to 95% by weight of a rubber-modified styrene-acrylonitrile copolymer, where the rubber component is based on an acrylate rubber or on a polybutadiene (PB). It is further preferable that the second thermoplastic molding composition M2 and the third thermoplastic molding composition M3 also comprise from 50% by weight to 95% by weight, in particular from 50% by weight to 70% by weight, of a polystyrene or of a styrene copolymer, in particular from 50% by weight to 95% by weight of a rubber-modified styrene-acrylonitrile copolymer, where the rubber component is based on an acrylate rubber or on a polybutadiene (PB).

The first thermoplastic molding composition M1 preferably comprises from 0.5% by weight to 20% by weight, more preferably from 1% by weight to 10% by weight and with particular preference from 2% by weight to 5% by weight, of a compatibilizer, where the compatibilizer comprises at least one styrene-acrylonitrile-maleic anhydride copolymer, where this has from 0.5% by weight to 30% by weight, more preferably from 1% by weight to 5% by weight of maleic-anhydride-derived units. It is preferable that this maleic anhydride content is from 1% by weight to 3% by weight, in particular from 2.0% by weight to 2.2% by weight.

The compatibilizer serves to improve adhesion of the polymer matrix on the moldings F in the first thermoplastic molding composition M1. By virtue of improved adhesion between the polymer matrix and the moldings F, the first thermoplastic molding composition M1 with compatibilizer has higher toughness than a first thermoplastic molding composition M1 comprising no compatibilizer. The toughness of the entire component is thus also increased. It is preferable that the compatibilizer comprises SAN and maleic anhydride. It is further preferable that the compatibilizer comprises from 70% by weight to 80% by weight of styrene monomers, from 20% by weight to 30% by weight of acrylonitrile monomers and from 1% by weight to 5% by weight of maleic anhydride, based on the entire composition of the compatibilizer. The compatibilizer can comprise polymers having functional groups, for example epoxy or imide groups, as alternative to maleic anhydride.

It is preferable that the first thermoplastic molding composition M1 comprises:
A) from 50 to 95% by weight of a styrene-acrylonitrile copolymer and/or of an α-methylstyrene-acrylonitrile copolymer as component A,
B) from 0 to 10% by weight of a graft polymer as component B comprising:
   B1: a graft base composed of an alkyl acrylate, an allyl (meth)acrylate, a copolymerizable monomer and/or a diene monomer,
   B2: at least one graft shell composed of at least one vinylaromatic monomer and/or one copolymerizable monomer,
C) from 0.1 to 10% by weight of the compatibilizer as component C,
D) from 5 to 30% by weight, often from 5 to 25% by weight, of moldings F as component D,
E) from 0 to 10% by weight of further components,
   where the entirety of components A, B, C, D and E (preferably) provides 100% by weight. The polymer matrix of the first thermoplastic molding composition M1 comprises the components A, B, C and E and preferably consists of the components A, B, C and E.

In a preferred embodiment, the second thermoplastic molding composition M2 and the third thermoplastic molding composition M3 in each case consist of the components A and C and optionally B and optionally E, and preferred compositions of the second thermoplastic molding composition M2 and of the third thermoplastic molding composition M3 here correspond to the preferred compositions of the polymer matrix of the first thermoplastic composition M1. The polymer matrix of the first thermoplastic molding composition M1 comprises no component D, and it is also preferable that the second thermoplastic molding composition M2 and the third thermoplastic molding composition M3 comprise no component D.

It is preferable here that the component A is an SAN copolymer, the component B is a graft copolymer of styrene and acrylonitrile and of a polybutadiene or acrylate rubber, and that the component C is an S/AN/MA copolymer.

It is further preferable that the first thermoplastic molding composition M1 comprises (or consists of):
A) from 50 to 95% by weight of a styrene-acrylonitrile copolymer as component A,
B) from 0 to 10% by weight of a graft polymer as component B comprising:
   B1: a graft base composed of an alkyl acrylate, an allyl (meth)acrylate, a copolymerizable monomer and/or a diene monomer,
   B2: at least one graft shell composed of at least one vinylaromatic monomer and/or one copolymerizable monomer,
C) from 0.5 to 8% by weight of another copolymer as compatibilizer as component C,
D) from 5 to 30% by weight, often from 5 to 25% by weight, of moldings F as component D,
E) from 0.1 to 4% by weight of stabilizer(s) as component E,
   where the entirety of components A, B, C, D and E provides 100% by weight.

It is preferable here that the component A is an SAN copolymer and that the component C is an S/AN/MA copolymer.

It is preferable that the component A is a styrene-acrylonitrile copolymer with from 65 to 76% by weight styrene content and with from 35 to 24% by weight acrylonitrile content.

In particular, the component A can be an SAN polymer with an S/AN ratio of 67/33 and viscosity number 80 dl/g (measured in 0.5% solution in DMF at 23° C.).

In a preferred embodiment, the first thermoplastic molding composition M1 comprises, as component E, from 0.05 to 5% by weight of at least two different stabilizers. A combination of two (or three) stabilizers (for example Tinuvin or Cyasorb) has proven advantageous.

In another preferred embodiment, at least some of the component A in the first thermoplastic molding composition M1 has been replaced by polyvinyl chloride. It is preferable that from 20% by weight to 60% by weight of the component A have been replaced by polyvinyl chloride (component A). It is thus advantageously possible to achieve better adhesion between the first thermoplastic molding composition M1 and another PVC component.

### Component A

In principle, any of the styrene-acrylonitrile copolymers known to the person skilled in the art and disclosed in the literature can be used as component A. For the purposes of the present invention, a styrene-acrylonitrile copolymer can also mean a ring-alkylated styrene-acrylonitrile copolymer. Component A is frequently an SAN matrix.

Quantities of component A used in the first thermoplastic molding composition M1 are preferably from 50% by weight to 95% by weight, more preferably from 50% by weight to 70% by weight.

Suitable monomers A1 for the copolymer are vinylaromatic monomers, preferably styrene and/or styrene derivatives, preferably α-methylstyrene, and ring-alkylated styrenes, for example p-methylstyrene and/or tert-butylstyrene. Compounds that can be used as monomers A2 for the copolymer are by way of example the following: acrylonitrile, methacrylonitrile, methyl acrylate, ethyl acrylate, propyl acrylate, methyl methacrylate, ethyl methacrylate, phenylmaleimide, acrylamide, vinyl methyl ether. It is preferable to use acrylonitrile.

The component A can be produced by well-known methods as described by way of example in DE-A 31 49 358, p. 9, lines 18 to 32 and DE-A 32 27 555, p. 9, lines 18 to 32, for example via well-known copolymerization of A1, A2 and optionally other copolymerizable monomers in bulk, solution, suspension or aqueous emulsion at conventional temperatures and pressures in known apparatuses, as described by way of example in Kunstsoff-Handbuch [Plastics handbook], Vieweg-Daumiller, vol. V (Polystyrene), Carl-Hanser-Verlag, Munich, 1969, p. 124, line 12 ff.

### Copolymer Component B

Quantities used of component B are preferably from 0% by weight to 10% by weight, more preferably from 0.5% by weight to 10% by weight.

Monomers that can be used for the production of the graft base are not only butadiene but also alkyl acrylates usually having from 1 to 8 carbon atoms, particularly preferably from 4 to 8 carbon atoms in the alkyl moiety, in particular n-butyl acrylate and/or ethylhexyl acrylate. The acrylateesters can be used individually or in a mixture in the production of the graft base B1.

Allyl (meth)acrylate, in particular allyl methacrylate, is suitable as crosslinking agent. It is optionally possible to use up to 2% by weight of other copolymerizable monomers having at least two functional groups, preferably up to 1% by weight and in particular up to 0.5% by weight. Suitable monomers are by way of example those comprising two or more ethylenic double bonds which are amenable to copolymerization and are not conjugated in 1,3-position. Examples of suitable crosslinking monomers are divinylbenzene, diallyl maleate, diallyl fumarate and/or diallyl phthalate, triallyl cyanurate, allyl (meth)acrylate, and preferably the acrylate ester of tricyclodecenyl alcohol and/or dicyclopentadienyl acrylate.

The following compounds can by way of example be used as possible other copolymerizable monomers: alpha-methylstyrene, methacrylonitrile, methyl acrylate, ethyl acrylate, propyl acrylate, methyl methacrylate, ethyl methacrylate, phenylmaleimide, acrylamide, vinyl methyl ether.

Preferred suitable vinylaromatic monomers B21 for the production of the shell(s) B2 grafted onto the graft base B1 are styrene and/or styrene derivatives, e.g. styrene and alkylstyrenes, preferably α-methylstyrene, and ring-alkylated styrenes, e.g. p-methylstyrene and/or tert-butylstyrene.

Examples of polar copolymerizable unsaturated monomers for B2 are acrylonitrile and methacrylonitrile.

The following compounds can by way of example be used as possible other monomers, in particular copolymerizable monomers, in particular for B2: acrylic acid, methacrylic acid, maleic anhydride, methacrylonitrile, methyl acrylate, ethyl acrylate, propyl acrylate, methyl methacrylate, ethyl methacrylate, phenylmaleimide, acrylamide, vinyl methyl ether. These can by way of example be used alone as grafted shell B2 or particularly preferably as copolymer in vinylaromatic monomers B21.

The first thermoplastic molding composition M1 can moreover use the conventional auxiliaries and/or additives, for example emulsifiers, e.g. alkali metal salts of alkyl- or alkylarylsulfonic acids, alkyl sulfates, fatty alcohol sulfonates, salts of higher fatty acids having from 10 to 30 carbon atoms or resin soaps, polymerization initiators, e.g. conventional persulfates, for example potassium persulfate or known redox systems, polymerization auxiliaries, e.g. conventional buffer substances used to establish pH values which are preferably from 6 to 9, e.g. sodium bicarbonate and/or sodium pyrophosphate, and/or molecular weight regulators, for example mercaptans, terpinols and/or dimeric α-methylstyrene, where the quantity used of the molecular weight regulators is usually from 0 to 3% by weight, based on the weight of the reaction mixture.

The production of the ASA (acrylate-styrene-acrylonitrile) material comprising the elastomeric graft base B1 made of acrylate polymer and the graft shell B2 made of styrene/acrylonitrile copolymer is well-known from the technical literature and is described by way of example in DE-A 12 60 135, pp. 3 to 4, lines 13 to 23 and U.S. Pat. No. 3,055,859, pp. 2 to 4, lines 62 to 10, and for two-stage grafting in DE-A 31 49 358, pp. 6 to 8, lines 16 to 5 and DE-A 32 27 555, pp. 6 to 8, lines 16 to 5. A possible method here begins by producing the elastomeric acrylate polymer serving as graft base A21, e.g. via emulsion polymerization of A211, for example by polymerizing A211 and the at least bifunctional crosslinking agent, for example in aqueous emulsion, in a manner known per se at temperatures of from 20 to 100° C., preferably from 50 to 80° C. A mixture of vinylaromatic monomers A221 with a polar copolymerizable unsaturated monomer A222 and optionally A223 can be grafted onto the resultant polyacrylate latex, the graft copolymerization here likewise preferably being carried out in aqueous emulsion.

It is also possible that, as described in EP 534,212 B1, pages 4 to 5, lines 46 to 43, the elastomeric component B1 is grafted onto a hard graft core which is composed of the monomers mentioned for A1 and which has been crosslinked with the monomers mentioned under A1. It is preferable that this is a hard graft core with glass transition temperature Tg>25° C., where the proportion of the graft core is, as previously described, from 5 to 50% by weight, based on the weight of A1.

Alternatively, the elastomeric graft base B1 can consist of diene monomers, and here it is preferable to use butadiene and isoprene, in particular butadiene, optionally in conjunction with other monomers, for example styrene.

In another particularly preferred embodiment, grafting can take place in two stages as in DE-A 31 49 358, pp. 6 to 8, lines 16 to 5 or DE-A 32 27 555, pp. 6 to 8, lines 1 to 5, where the vinylaromatic monomer can first be polymerized in the presence of the graft base. The graft copolymerization can then be carried out in the second stage with a mixture comprising at least one vinylaromatic monomer and at least one polar copolymerizable monomer. The quantities used, and the quantities comprised in the ASA materials, of the various components have already been described in the introduction.

In order to achieve ASA materials with good mechanical properties, the polyacrylate serving as graft base has been crosslinked, i.e. production thereof via polymerization of acrylates takes place in the presence of at least bifunctional crosslinking monomers.

The first thermoplastic molding composition M1 can preferably comprise from 0.5% by weight to 30% by weight, often from 0.5% by weight to 15% by weight, of at least one graft polymer as component B, consisting of:
a) from 10% by weight to 90% by weight of graft base B1 made of (partially) crosslinked polybutadiene or polyacrylate
b) from 90% by weight to 10% by weight of one or more grafts B2 made of styrene, acrylonitrile and optionally other monomers, for example methyl methacrylate (MMA).

In another embodiment, up to 50% by weight of one or more components B can be added as impact modifier to the first thermoplastic molding composition M1 in order to improve mechanical properties. In particular, the component B can at least to some extent replace the component A in the first thermoplastic molding composition M1.

### Component C

Quantities used of component C are often from 0.5% by weight to 20% by weight, preferably from 1% by weight to 10% by weight and in particular from 2% by weight to 5% by weight. The component is preferably a copolymer.

It is preferable that the first thermoplastic molding composition M1 comprises the compatibilizer as component C.

Component C is particularly preferably a styrene-acrylonitrile-maleic anhydride terpolymer. The proportion of acrylonitrile in the terpolymer, based on the entire terpolymer, is preferably from 10% by weight to 30% by weight, particularly preferably from 15% by weight to 30% by weight, in particular from 20% by weight to 25% by weight. The remainder is made up by styrene and maleic anhydride.

The molar masses Mw of the maleic-anhydride-containing (methyl)styrene-acrylonitrile copolymers preferably used is generally in the range from 30 000 to 500 000 g/mol, preferably from 50 000 to 250 000 g/mol, in particular from 70 000 to 200 000 g/mol, determined via GPC with use of tetrahydrofuran (THF) as eluent and with polystyrene calibration.

### Further Components E

For the purposes of another embodiment, the first thermoplastic molding composition M1 comprises from 0.01% by weight to 10% by weight, often from 0.1 to 5% by weight, of at least one further component E, in particular as auxiliary and/or additive. Quantities preferably used of component E are from 0.01% by weight to 5% by weight, more preferably from 0.025% by weight to 2% by weight and in particular from 0.05% by weight to 1.5% by weight. It is possible here to use individual constituents in the component or a plurality of constituents in the component.

The first thermoplastic molding composition M1 can comprise auxiliaries and/or additives in addition to the components A to D. The auxiliaries and additives are in particular different from the moldings F and different from the compatibilizer. Particular preference is given to a first thermoplastic molding composition M1 comprising up to 5% by weight of auxiliaries and/or additives. Examples of auxiliaries and/or additives that can be used are light stabilizers and other stabilizers, plasticizers, antistatic agents, lubricants, blowing agents, other compatible thermoplastics, for example polyesters (e.g. polyethylene terephthalate, polybutylene terephthalate), polycarbonate, polyamide, polyoxymethylene, polystyrene, polyethylene, polypropylene, polyvinyl chloride, fillers, surface-active substances, flame retardants, dyes and pigments.

Quantities preferably comprised of stabilizers in respect of oxidation, hydrolysis, light, heat or discoloration are preferably from 0.1% by weight to 5% by weight. The materials often comprise two different types of stabilizer.

For the purposes of another embodiment of the first thermoplastic molding composition M1, the component E comprises a light stabilizer, a lubricant and a (medicinal) white oil. In particular, the component E can consist of a plurality of substances, in order by way of example to influence the appearance of the molding composition. To this end, the material can preferably comprise optical brighteners, free-radical scavengers which scavenge free radicals generated in the molding composition via UV radiation, or light stabilizers.

Lubricants and mold-release agents, quantities of up to 1% by weight of which can generally be added, are stearic acid, stearyl alcohol, alkyl stearates, and stearamides, and also esters of pentaerythritol with long-chain fatty acids. It is also possible to use stearic salts of calcium, of zinc, or of aluminum, and also dialkyl ketones, e.g. distearyl ketone. In particular, calcium stearate is suitable.

Light stabilizers that can be used are any of the conventional light stabilizers, for example compounds based on benzophenone, on benztriazole, on cinnamic acid, or on organic phosphites and phosphonites; it is also possible to use sterically hindered amines.

Examples of lubricants that can be used are hydrocarbons such as oils, paraffins, PE waxes, PP waxes, fatty alcohols having from 6 to 20 carbon atoms, ketones, carboxylic acids such as fatty acids, montanic acid, or oxidized PE wax, carboxamides, and also carboxylic esters, e.g. with the following alcohols: ethanol, fatty alcohols, glycerol, ethanediol, pentaerythritol, and with long-chain carboxylic acids as acid component.

Stabilizers that can be used are conventional antioxidants, for example phenolic antioxidants, e.g. alkylated monophenols, esters and/or amides of β-(3,5-di-tert-butyl-4-hydroxyphenyhpropionic acid, and/or benztriazoles. Possible antioxidants are mentioned by way of example in EP-A 698637 and EP-A 669367. Specifically, mention may be made of the phenolic antioxidants 2,6-di-tert-butyl-4-methylphenol, pentaerythritol tetrakis-[3-(3,5-di-tert-butyl-4-hydroxyphenyl)]propionate, and N,N′-di-(3,5-di-tert-butyl-4-hydroxyphenylpropionyl)hexamethylenediamine. The stabilizers mentioned can be used individually or in mixtures. The stabilizer Tinuvin 770 has proven to be particularly suitable, often in combination with another stabilizer (see experimental section). Tinuvin 770 is a low-molecular-weight dicarboxylic ester with the systematic name: bis(2,2,6,6-tetramethyl-4-piperidinyl) decanedioate. A suitable material in combination is by way of example Cyasorb UV-3853 (see Hostavin N845N), a mixture of low-molecular-weight fatty acid esters with a heterocyclic alcohol (C₁₂₋₂₁ and C₁₈-unsaturated-2,2,6,6-tetramethyl-4-piperidinyl ester). Another suitable material is Chimassorb 944 (HALS-HS-944), a mixture of oligomeric HALS stabilizers with the molecular formula (C₃₅H₆₈N₈)ₙ having various chain lengths (poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]).

The first thermoplastic molding composition M1 is preferably produced by mixing of the components A, B, C and D and E in the melt.

In another embodiment, the components A, C, D, E and optionally B are compounded. A compounding (plastics compounding) process can be carried out here to achieve the desired optimization of property profiles via admixture of additional substances (fillers, additives, etc.). In particular, the component E can be used for this purpose.

The components A, B, C and D can be used simultaneously or in succession. For the purposes of the present invention, in succession means that by way of example two components are mixed first and then the other components are added. The compounding process takes place mainly in extruders (predominantly corotating twin-screw extruders, or else contrarotating twin-screw extruders or co-kneaders), and comprises the process operations of conveying, melting, dispersion, mixing, devolatilization and compression.

A process is moreover provided for the production of the component of the invention, where the core K, the coating G and, if present, the further layer S are produced by means of injection molding. Other processes that can be used, alongside injection molding, for the production of the component are in general extrusion, calendering and rolling.

The component of the invention can be produced by first producing the core K, and then in a subsequent step applying the coating G to said core, and then in a further step applying, if present, the further layer S to said core. It is also possible to apply the coating G and the further layer S simultaneously to the core K by means of injection molding.

In an alternative embodiment it is possible that the core K and the coating G and also, if present, the further layer S are simultaneously injected into a cavity, and that the core K, the coating G and, if present, the further layer S are thus produced simultaneously and that the component is thus produced. Simultaneous production of the core K, the coating G and, if present, the further layer S is possible by way of example by means of multicomponent injection-molding processes. Multicomponent injection-molding processes are described by way of example in W. Michaeli, et al., in Technologie des Spritzgieβens [Injection-molding technology], Carl Hansa Verlag, Munich, 2009, starting at p. 78.

The invention is explained in more detail below with reference to the drawings.

In the figures:

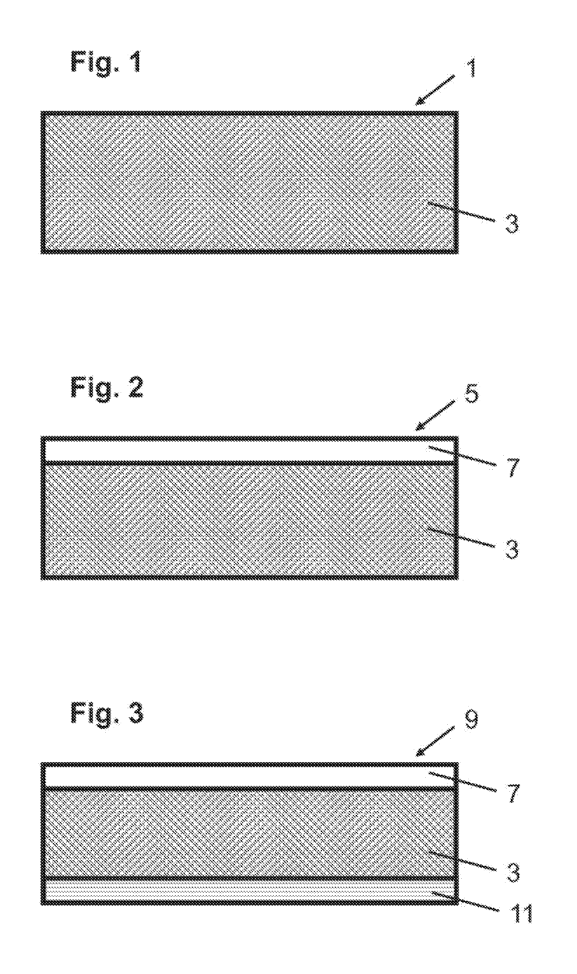

FIG. 1 shows a detail of a component of the prior art,

FIG. 2 shows a detail of a component of the invention and

FIG. 3 shows a detail of a component of the invention with a further layer S.

FIG. 1 shows a detail of a component 1 of the prior art. The component 1 can by way of example be a center console in the interior of a vehicle.

The component 1 consists entirely of the first thermoplastic molding composition M1, which has glass spheres as moldings F, and thus consists exclusively of a core K 3. The interior of the glass spheres comprised in the first thermoplastic molding composition M1 comprises a cavity.

FIG. 2 shows a detail of a component 5 of the invention, having a core K 3 consisting of a first thermoplastic molding composition M1, and a coating G 7 consisting of a second thermoplastic molding composition M2. Unlike the first thermoplastic molding composition M1, the second thermoplastic molding composition M2 comprises no glass spheres. The location of the coating G 7 in this embodiment is only on one side of the component 5. Comparison with the component 1 of the prior art shown in FIG. 1 reveals that a portion of the first thermoplastic molding composition M1 has been replaced by the second thermoplastic molding composition M2. Alternatively, it is also possible that the coating G 7, and therefore the second thermoplastic molding composition M2, is applied additionally by way of example to the previously manufactured component 1 of the prior art.

FIG. 3 shows a detail of a component 9 of the invention which comprises a core K 3 consisting of the first thermoplastic molding composition M1, a coating G 7 consisting of the second thermoplastic molding composition M2, and a further layer S 11 consisting of the third thermoplastic molding composition M3. The coating G 7 and the further layer S 11 are arranged on opposite sides of the core K 3 on the component 9. Neither the second thermoplastic molding composition M2 nor the third thermoplastic molding composition M3 comprises glass spheres. The composition of the second thermoplastic molding composition M2 differs here from the composition of the third thermoplastic molding composition M3, and it is therefore possible to achieve different types of surface on different sides of the core K 3.

The proportion, based on mass, of the first thermoplastic molding composition M1 in the component 9 here is greater than the sum of the proportions, based on mass, of the second thermoplastic molding composition M2 and of the third thermoplastic molding composition M3 in the component 9. The same also applies to the proportions based on volume. The thickness of the coating G 7 is constant in this embodiment, as is the thickness of the further layer S 11. Alternatively, it is also possible that the thicknesses of the coating G 7 and of the further layer S 11 vary in accordance with the shape of the core K 3 or else independently of the shape of the core K 3, in order by way of example to produce desired elevations/depressions on the surface of the component 9.

### EXAMPLE

A sheet measuring 10 cm×10 cm×1.5 cm is produced as component from a thermoplastic styrene-copolymer-composite material comprising a thermoplastic core K (85% by weight of the component) and a polymer coating G (15% by weight of the component), where the coating G entirely encloses the core K. The core K is produced from 75% by weight of a commercially available thermoplastic SAN copolymer M1 (produced by Styrolution, Frankfurt), where this thermoplastic molding composition M1 comprises 25% by weight of moldings F (hollow glass spheres with average external diameter 0.4 mm and average wall thickness 0.08 mm). The thin coating G of the component is produced from a thermoplastic molding composition made of ABS copolymer (Terluran GP-35), and is applied to the core.

1-17. (canceled)

18. A component made of thermoplastic composite material, comprising a core K and at least one coating G, where:
the coating G at least to some extent encloses the core K,
the core K has been produced from a first thermoplastic molding composition M1,
where
the first thermoplastic molding composition M1 comprises a plurality of moldings F, and the coating G has been produced from a second thermoplastic molding composition M2,
the thickness of the core K is greater by a factor of at least 1.2 and at most 20 than the thickness of the coating G, where in each case the value to be adduced is the greatest thickness, based on the entire component;
the moldings F are hollow bodies and in particular have a ratio of the average external diameter of the moldings F to the average wall thickness of the moldings F of from 2.05 to 10;
the notched impact resistance (DIN EN ISO 179-1) of the second thermoplastic molding composition M2 is higher than that of the first thermoplastic molding composition M1;
the density of the first thermoplastic molding composition M1 is from 0.7 to 1 g/cm3, and the thermoplastic molding composition M1 comprises:
A) at least 50% by weight of a styrene-acrylonitrile copolymer as component A,
B) from 0 to 10% by weight of a graft polymer as component B comprising:
B1: a graft base composed of an alkyl acrylate, an allyl (meth)acrylate, a copolymerizable monomer and/or a diene monomer,
B2: at least one graft shell composed of at least one vinylaromatic monomer and/or one copolymerizable monomer,
C) from 0.5 to 8% by weight of another copolymer as compatibilizer as component C,
D) from 5 to 30% by weight, often from 5 to 25% by weight, of moldings F as component D,
E) from 0.1 to 4% by weight of stabilizer(s) as component E;
where the entirety of components A, B, C, D and E provides 100% by weight.

19. The component as claimed in claim 18, characterized in that, based on the composition of the moldings F, at least 60% by weight of said moldings consists of glass.

20. The component as claimed in claim 18, characterized in that the moldings F are spherical.

21. The component as claimed in claim 18, characterized in that the longest spatial dimension of the moldings F is in the range from 1 μm to 1000 μm.

22. The component as claimed in claim 18, characterized in that the thermoplastic molding composition M1 consists of the components A, B, C, D and E.

23. The component as claimed in claim 18, characterized in that the coating G is a film, a sheet or a second component, in particular a film.

24. The component as claimed in claim 18, characterized in that the first thermoplastic molding composition M1 consists of a polymer matrix and of the moldings F, and the composition of the polymer matrix of the first thermoplastic molding composition M1 and of the second thermoplastic molding composition M2 is identical.

25. The component as claimed in claim 18, characterized in that the component additionally comprises a further layer S which is composed of a third thermoplastic molding composition M3 which has higher notched impact resistance than the first thermoplastic molding composition M1, where the core K is arranged between the coating G and the further layer S.

26. The component as claimed in claim 18, characterized in that the coating G is arranged in direct contact with the core K and, if present, the further layer S is arranged in direct contact with the core K.

27. The component as claimed in claim 18, characterized in that the coating G and, if present, the further layer S form an exterior surface of the component.

28. The component as claimed in claim 18, characterized in that the first thermoplastic molding composition M1 comprises at least 50% by weight of a rubber-modified styrene-acrylonitrile copolymer, where the rubber component is based on an acrylate rubber or on a polybutadiene (PB).

29. The component as claimed in claim 18, characterized in that the compatibilizer comprises at least one styrene-acrylonitrile-maleic anhydride copolymer, where this has from 0.5% by weight to 30% by weight of maleic-anhydride-derived units.

30. A process for the production of a component as claimed in claim 18, where the core K, the coating G and, if present, the further layer S are produced by means of injection molding.
